(19) United States
(12) Patent Application Publication
(10) Pub. No.: US 2018/0281892 A1
(43) Pub. Date: Oct. 4, 2018

(54) ANTI-DISENGAGEMENT FINE-ADJUSTABLE QUICK-DETACHABLE STRUCTURE

(71) Applicant: SHUN XIN CO., LTD., Taichung City (TW)

(72) Inventor: Chin-Chao Chang, Taichung City (TW)

(21) Appl. No.: 15/476,765

(22) Filed: Mar. 31, 2017

(51) Int. Cl. B62K 25/02; F16B 9/02

(52) U.S. Cl. CPC B62K 25/02; B62K 2206/00; F16B 9/026

(57) ABSTRACT

The utility model discloses an anti-disengagement fine-adjustable quick-detachable structure, which comprises a shaft lever, a spanner rod and a fine-adjustable unit; wherein the shaft lever has a small-diameter portion and a large-diameter portion, an anti-disengagement end face is formed at a junction between the small-diameter portion and the large-diameter portion, and the spanner rod is screwed to one end of the shaft lever; and the fine-adjustable unit has an inner sleeve and an outer sleeve, the inner sleeve has an axially penetrating through hole and a fine-adjustable external thread, the outer sleeve is hollow annular, a small-diameter hole and a large-diameter hole communicated with the small-diameter hole are arranged on an inner circumferential surface of the outer sleeve, a fine-adjustable internal thread is arranged on a hole wall of the small-diameter hole, the fine-adjustable internal thread of the outer sleeve is screwed onto the fine-adjustable external thread of the inner sleeve such that the outer sleeve rotates under an external force to move in a reciprocating manner along an axial direction of the inner sleeve, the through hole of the inner sleeve allows the shaft lever to pass through, the inner diameter of the large-diameter hole is greater than the outer diameter of the large-diameter portion of the shaft lever, and the inner diameter of the small-diameter hole is smaller than the outer diameter of the large-diameter portion of the shaft lever, thereby achieving the effect of preventing component disengagement.

### FIELD OF THE UTILITY MODEL

The utility model relates to the field of quick-detachable structures for bicycles, and more specifically to an anti-disengagement fine-adjustable quick-detachable structure.

### BACKGROUND OF THE UTILITY MODEL

A quick-detachable structure of a bicycle is mainly used to allow quick assembling and disassembling of wheels and a frame (or a fork on the frame).

There are various types of bicycles such as mountain bicycles, snow bicycles, downhill bicycles and road bicycles. For a quick-detachable structure used in a mountain bicycle or a downhill bicycle requiring significant impact strength, an external thread is disposed at one end of a shaft lever and thus screwed to an internal thread of the frame, thereby improving the impact strength. However, such quick-detachable structure screwed and locked to the frame by means of threads has the disadvantages that the tension can only be adjusted by a one-side spanner rod, and thus the position of the spanner rod cannot be easily controlled. If the spanner rod is orientated downwards, the quick-detachable structure may be disengaged due to impact on the spanner rod by foreign matter, but if the spanner rod is forcibly secured upwards, the engagement may be too loose or too tight.

Accordingly, the inventor has developed a fine-adjustable quick-detachable structure, which is mainly achieved as follows: a fine-adjustable unit is added between a shaft lever and a spanner rod, and then axial fine-adjustable movement is performed by inner and outer sleeves of a retention mechanism, thus a small space is formed between the fine-adjustable unit and the fork to ensure that the spanner rod is rotated and then wrenched. However, before such fine-adjustable quick-detachable structure is assembled on a frame, its outer sleeve easily disengages from one end of the shaft lever at which an external thread is disposed due to careless use by a user, thus components are easily lost.

### SUMMARY OF THE UTILITY MODEL

In view of this, the utility model provides an anti-disengagement fine-adjustable quick-detachable structure so as to solve the problem that components of a conventional quick-detachable structure are easily disengaged in the prior art. To achieve the above object, the utility model employs the following technical solution: an anti-disengagement fine-adjustable quick-detachable structure comprises: a shaft lever having a mandrel and a connecting shaft, wherein the mandrel has a fixed end and a fine-adjustable end joined to the fixed end, a mandrel external thread is arranged on an outer circumferential surface of the fixed end, a mandrel internal thread is arranged on an end face of the fine-adjustable end, a small-diameter portion adjacent to the end face and a large-diameter portion connected with the small-diameter portion are arranged on an outer circumferential surface of the fine-adjustable end, the outer diameter of the small-diameter portion is smaller than that of the large-diameter portion, an anti-disengagement end face is formed at a junction between the small-diameter portion and the large-diameter portion, the connecting shaft has a first external thread at one end and a second external thread at the other end, and the first external thread is screwed to the mandrel internal thread of the mandrel; a spanner rod having a positioning post internal thread which is screwed to the second external thread of the shaft lever; and a fine-adjustable unit having an inner sleeve and an outer sleeve, wherein the inner sleeve has an axially penetrating through hole and a fine-adjustable external thread, the outer sleeve is hollow annular, a small-diameter hole and a large-diameter hole communicated with the small-diameter hole are arranged on an inner circumferential surface of the outer sleeve, the inner diameter of the small-diameter hole is smaller than that of the large-diameter hole, a fine-adjustable internal thread is arranged on a hole wall of the small-diameter hole, the fine-adjustable internal thread of the outer sleeve is screwed onto the fine-adjustable external thread of the inner sleeve such that the outer sleeve can rotate under an external force to move in a reciprocating manner along an axial direction of the inner sleeve, the through hole of the inner sleeve allows the connecting shaft of the shaft lever to pass through, the inner diameter of the large-diameter hole is greater than the outer diameter of the large-diameter portion of the shaft lever, and the inner diameter of the small-diameter hole is smaller than the outer diameter of the large-diameter portion of the shaft lever, thereby achieving the effect of preventing component disengagement.

### BRIEF DESCRIPTION OF THE DRAWINGS

FIG. 1 is an exploded perspective view of a first preferred embodiment of the utility model;

FIG. 2 is an assembled perspective view of the embodiment shown in FIG. 1;

FIGS. 3 to 5 are schematic views for operation of the embodiment shown in FIG. 1;

FIG. 6 is an exploded perspective view of a second preferred embodiment of the utility model;

FIG. 7 is an assembled schematic sectional view of the embodiment shown in FIG. 6;

FIG. 8 is an exploded perspective view of a third preferred embodiment of the utility model;

FIG. 9 is an assembled schematic sectional view of the embodiment shown in FIG. 8;

FIG. 10 is an assembled schematic sectional view of a fourth preferred embodiment of the utility model; and

FIG. 11 is an assembled schematic sectional view of the embodiment shown in FIG. 10.

In the Figures: [first preferred embodiment]: anti-disengagement fine-adjustable quick-detachable structure 100, shaft lever 10, mandrel 11, fixed end 111, fine-adjustable end 112, mandrel external thread 113, mandrel internal thread 114, small-diameter portion 116, large-diameter portion 118, anti-disengagement end face 119, connecting shaft 12, first external thread 121, second external thread 122, fine-adjustable unit 20, inner sleeve 21, head 211, body 212, through hole 213, fine-adjustable external thread 214, outer sleeve 22, small-diameter hole 221, large-diameter hole 222, fine-adjustable internal thread 223, spanner rod 0, rod body 31, positioning post 32, positioning post internal thread 321, pressing block 33, perforation 331, fork 1, shaft hole 2, space S; [second preferred embodiment]: anti-disengagement fine-adjustable quick-detachable structure 200, shaft lever 40, mandrel 41, small-diameter portion 416, washer 43, fine-adjustable unit 50, outer sleeve 52, small-diameter hole 521, large-diameter hole 522, spanner rod 60; [third preferred embodiment]: anti-disengagement fine-adjustable quick-detachable structure 300, shaft lever 70, mandrel 71, fine-adjustable end 712, annular groove 717, C-shaped snap ring 74, fine-adjustable unit 80, outer sleeve 82, small-diameter hole 821, large-diameter hole 822, spanner rod 90; [fourth preferred embodiment]: anti-disengagement fine-adjustable quick-detachable structure 400, shaft lever 10, connecting shaft 12, mandrel internal thread 114, fine-adjustable unit 3, knob 4, knob head 5, knob body 6, knob perforation 7, knob external thread 8, spanner rod 30.

### DETAILED DESCRIPTION OF THE UTILITY MODEL

In order to further understand the features and characteristics of the utility model, the following preferred embodiments are listed and described below with reference to the drawings.

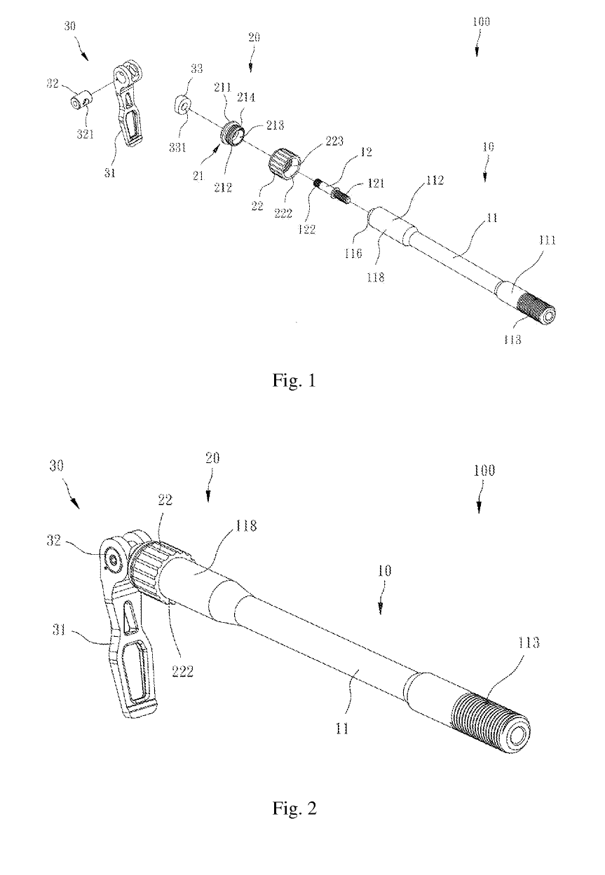

Referring to FIGS. 1 to 5, an anti-disengagement fine-adjustable quick-detachable structure 100 provided by a first preferred embodiment of the utility model mainly comprises a shaft lever 10, a fine-adjustable unit 20 and a spanner rod 30.

Referring to FIGS. 1 to 3, the shaft lever 10 has a mandrel 11 and a connecting shaft 12. The mandrel 11 has a fixed end 111 and a fine-adjustable end 112 joined to the fixed end, a mandrel external thread 113 is arranged on an outer circumferential surface of the fixed end 111, a mandrel internal thread 114 is arranged on an end face of the fine-adjustable end 112, a small-diameter portion 116 adjacent to the end face and a large-diameter portion 118 connected with the small-diameter portion 116 are arranged on an outer circumferential surface of the fine-adjustable end 112, the outer diameter of the small-diameter portion 116 is smaller than that of the large-diameter portion 118, and an anti-disengagement end face 119 is formed at a junction between the small-diameter portion 116 and the large-diameter portion 118; and the connecting shaft 12 has a first external thread 121 at one end and a second external thread 122 at the other end, and the first external thread 121 of the connecting shaft 12 is screwed and secured to the mandrel internal thread 114 of the mandrel 11.

Referring to FIGS. 1 to 3, the fine-adjustable unit 20 has an inner sleeve 21 and an outer sleeve 22. The inner sleeve 21 has a head 211, a body 212 joined at one end of the head 211 and a through hole 213 axially penetrating through the head 211 and the body 212, the outer diameter of the head 211 is greater than that of the body 212, and a fine-adjustable external thread 214 is arranged on an outer circumferential surface of the body 212; the outer sleeve 22 is hollow annular, a small-diameter hole 221 and a large-diameter hole 222 communicated with the small-diameter hole 221 are arranged on an inner circumferential surface of the outer sleeve 22, the inner diameter of the small-diameter hole 221 is smaller than that of the large-diameter hole 222, and a fine-adjustable internal thread 223 is arranged on a hole wall of the small-diameter hole 221; and the fine-adjustable internal thread 223 of the outer sleeve 22 is screwed onto the fine-adjustable external thread 214 of the inner sleeve 21 such that the outer sleeve 22 can rotate under an external force to move in a reciprocating manner along an axial direction of the inner sleeve 21, and the through hole 213 of the inner sleeve 21 allows the connecting shaft 12 of the shaft lever 10 to pass through.

Referring to FIGS. 1 to 3, the spanner rod 30 has a rod body 31, a positioning post 32 and a pressing block 33; and a positioning post internal thread 321 is arranged at one side of the positioning post 32, the positioning post 32 is placed in one end of the rod body 31 and relatively movable, the pressing block 33 has a perforation 331, the perforation 332 of the pressing block 33 allows the connecting shaft 12 of the shaft lever 10 to pass through, and the positioning post internal thread 321 of the positioning post 32 is screwed to the second external thread 122 of the shaft lever 10.

Accordingly, various components and members of an anti-disengagement fine-adjustable quick-detachable structure 100 provided by the first preferred embodiment of the utility model as well as their assembling ways have been introduced above, and then their use characteristics will be described below.

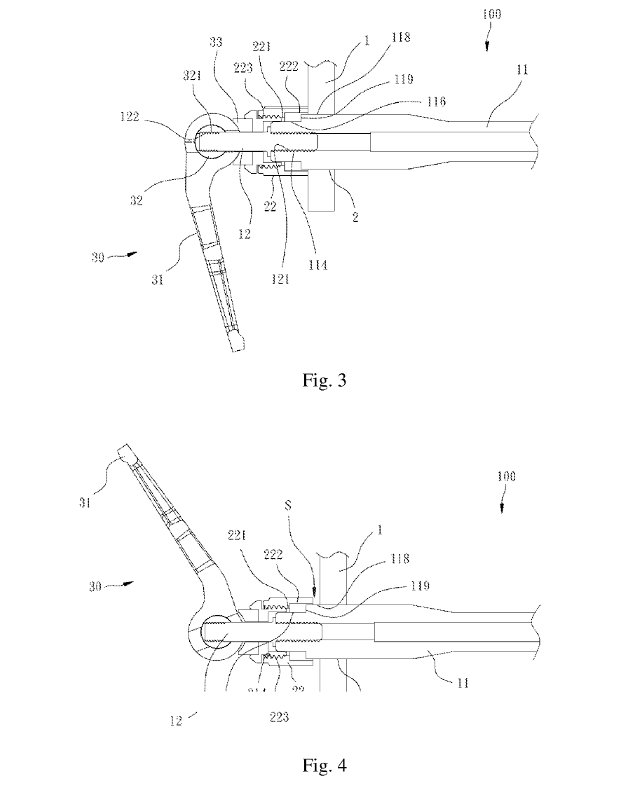

When the technical solution is employed, the shaft lever 10 firstly passes through a shaft hole 2 of a fork 1 of a bicycle (as shown in FIG. 3), and the mandrel external thread 113 is screwed to the fork 1 (not shown) such that the fine-adjustable unit 20 is located between the fork 1 and the spanner rod 30.

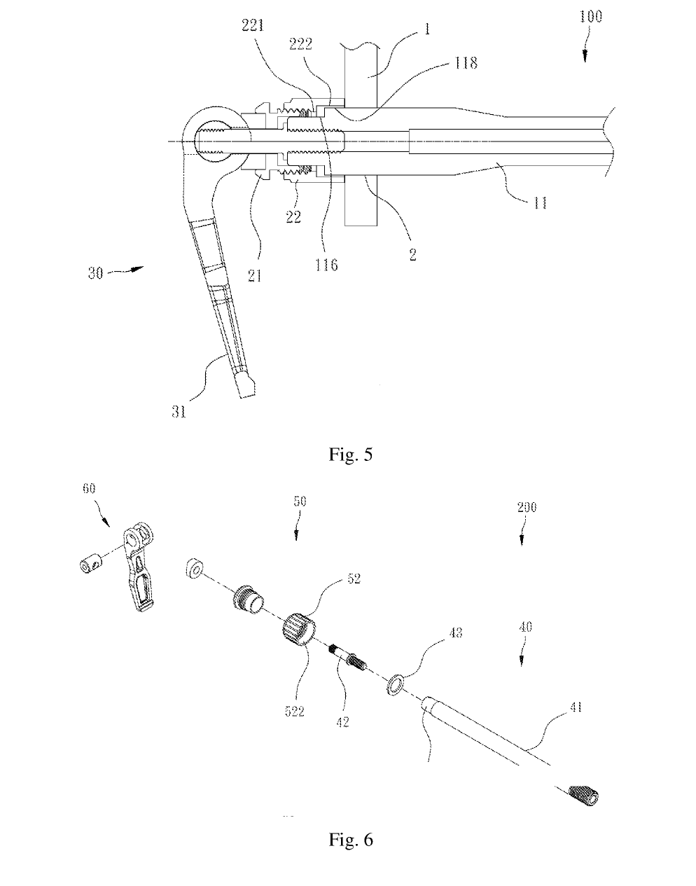

When the spanner rod 30 presses downward or forward (i.e. not upward), the spanner rod 30 can be unscrewed in advance (as shown in FIG. 4), and the outer sleeve 22 is slightly rotated such that the outer sleeve 22 moves slightly along an axial direction of the inner sleeve 21 (as shown in FIG. 4) and a small space S is formed between the fine-adjustable unit 20 and the fork 1. In this way, the space S formed can ensure that the spanner rod 30 is rotated to an upward or backward direction and then wrenched (as shown in FIG. 5), which can prevent the spanner rod 30 from disengagement caused by impact from foreign matter on the ground when the bicycle is moving, thus improving the safety in use.

Furthermore, in the utility model, the aperture of the small-diameter hole 221 of the outer sleeve 22 of the fine-adjustable unit 20 is smaller than the outer diameter of the large-diameter portion 118 of the shaft lever 10, and the aperture of the large-diameter hole 222 is greater than the outer diameter of the large-diameter portion 118 of the shaft lever 10. Accordingly, before the anti-disengagement fine-adjustable quick-detachable structure of the technical solution is assembled with the fork 1, if the large-diameter hole 222 moves outside the large-diameter portion 118, an end face of the small-diameter hole 221 is abutted and blocked by the anti-disengagement end face 119 such that the outer sleeve 22 cannot disengage outside the shaft lever 10, thus achieving the effect of preventing component loss.

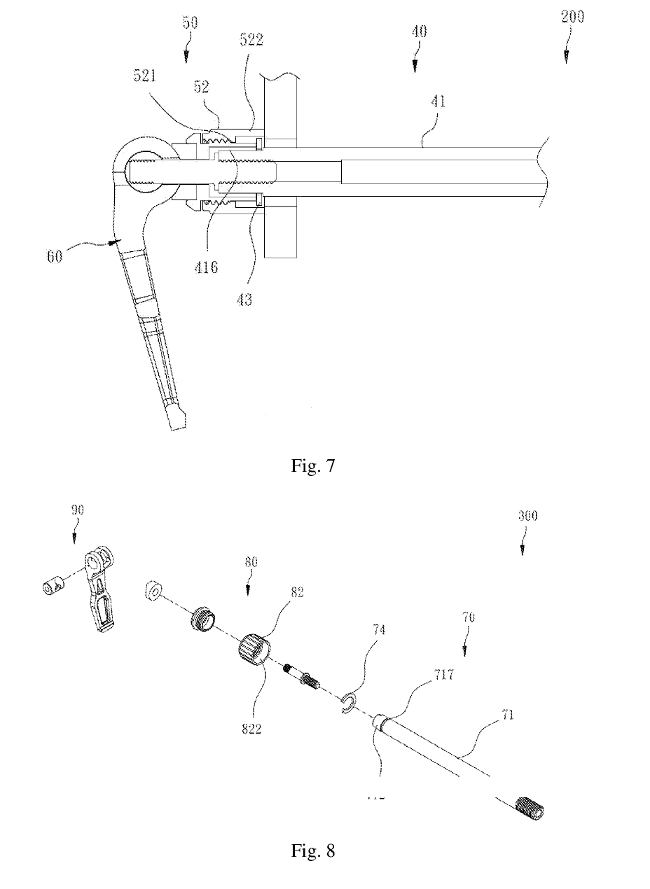

Referring to FIGS. 6 to 7, an anti-disengagement fine-adjustable quick-detachable structure 200 provided by a second preferred embodiment of the utility model comprises a shaft lever 40, a fine-adjustable unit 50 and a spanner rod 60 as in the foregoing embodiment. The main difference is as follows:

In the embodiment, the shaft lever 40 also has a washer 43, wherein the washer 43 is sleeved on the small-diameter portion 416 of the mandrel 41, such that an end face of the small-diameter hole 521 is abutted and blocked by the washer 43 when the large-diameter hole 522 of the outer sleeve 52 moves outside the mandrel 41, thereby achieving the anti-disengagement effect.

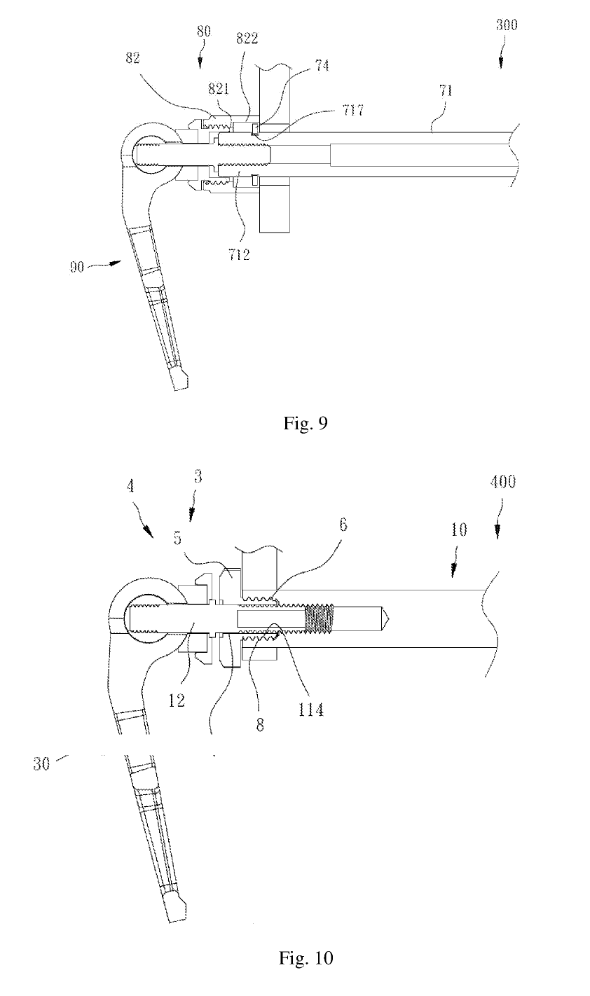

Referring to FIGS. 8 to 9, an anti-disengagement fine-adjustable quick-detachable structure 300 provided by a third preferred embodiment of the utility model comprises a shaft lever 70, a fine-adjustable unit 80 and a spanner rod 90 as in the first embodiment. The main difference is as follows:

In the embodiment, the shaft lever 70 also has a C-shaped snap ring 74; an annular groove 717 is arranged on an outer circumferential surface of the fine-adjustable end 712 of the mandrel 71; and the C-shaped snap ring 74 is clamped and secured on the annular groove 717 such that an end face of the small-diameter hole 821 is abutted and blocked by the C-shaped snap ring 74 when the large-diameter hole 822 of the outer sleeve 82 moves outside the mandrel 71, thereby achieving the anti-disengagement effect.

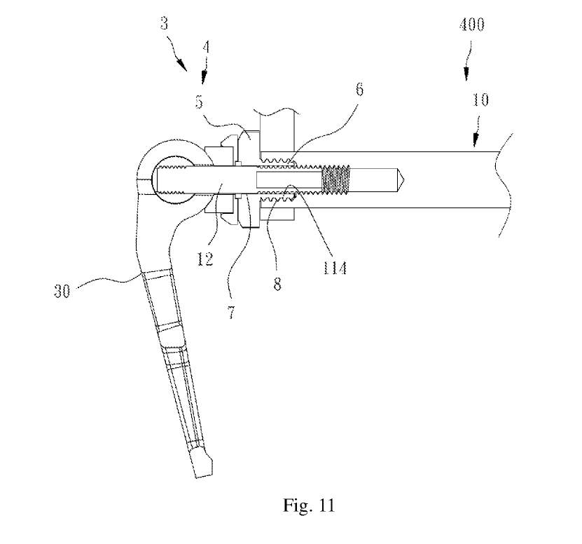

Referring to FIGS. 10 to 11, an anti-disengagement fine-adjustable quick-detachable structure 400 provided by a fourth preferred embodiment of the utility model comprises a shaft lever 10, a fine-adjustable unit 3 and a spanner rod 30 as in the first embodiment. The main difference is as follows:

In the embodiment, the fine-adjustable unit 3 has a knob 4, wherein the knob 4 has a knob head 5, a knob body 6 connected at one end of the knob head 5 and a knob perforation 7 penetrating through the knob head 5 and the knob body 6, the outer diameter of the knob head 5 is greater than that of the knob body 6, and a knob external thread 8 is arranged on an outer surface of the knob body 6.

The knob perforation 7 of the fine-adjustable unit 3 allows the connecting shaft 12 of the shaft lever 10 to pass through, and the knob external thread 8 is screwed to the mandrel internal thread 114 of the shaft lever 10 such that the knob 4 can rotate under an external force to move in a reciprocating manner along an axial direction of the shaft lever 10.

In this way, the embodiment also can effectively prevent the fine-adjustable unit 3 from disengaging outside the shaft lever 10.

1. An anti-disengagement fine-adjustable quick-detachable structure, comprising:
a shaft lever having a mandrel and a connecting shaft, the mandrel having a fixed end and a fine-adjustable end joined to the fixed end, a mandrel external thread being arranged on an outer circumferential surface of the fixed end, a mandrel internal thread being arranged on an end face of the fine-adjustable end, a small-diameter portion adjacent to the end face and a large-diameter portion connected with the small-diameter portion being arranged on an outer circumferential surface of the fine-adjustable end, the outer diameter of the small-diameter portion being smaller than that of the large-diameter portion, an anti-disengagement end face being formed at a junction between the small-diameter portion and the large-diameter portion, the connecting shaft having a first external thread at one end and a second external thread at the other end, and the first external thread being screwed to the mandrel internal thread of the mandrel;
a spanner rod having a positioning post internal thread which is screwed to the second external thread of the shaft lever; and
a fine-adjustable unit having an inner sleeve and an outer sleeve, the inner sleeve having an axially penetrating through hole and a fine-adjustable external thread, the outer sleeve being hollow annular, a small-diameter hole and a large-diameter hole communicated with the small-diameter hole being arranged on an inner circumferential surface of the outer sleeve, the inner diameter of the small-diameter hole being smaller than that of the large-diameter hole, a fine-adjustable internal thread being arranged on a hole wall of the small-diameter hole, the fine-adjustable internal thread of the outer sleeve being screwed onto the fine-adjustable external thread of the inner sleeve such that the outer sleeve can rotate under an external force to move in a reciprocating manner along an axial direction of the inner sleeve, the through hole of the inner sleeve allowing the connecting shaft of the shaft lever to pass through, the inner diameter of the large-diameter hole being greater than the outer diameter of the large-diameter portion of the shaft lever, and the inner diameter of the small-diameter hole being smaller than the outer diameter of the large-diameter portion of the shaft lever.

2. The anti-disengagement fine-adjustable quick-detachable structure according to claim 1, wherein the inner sleeve of the fine-adjustable unit has a head and a body joined at one end of the head, the through hole axially penetrates through the head and the body, the outer diameter of the head is greater than that of the body, and the fine-adjustable external thread is located on an outer circumferential surface of the body.

3. The anti-disengagement fine-adjustable quick-detachable structure according to claim 1, wherein the spanner rod has a rod body, a positioning post and a pressing block, the positioning post internal thread is located at one side of the positioning post, the positioning post is placed in one end of the rod body and relatively movable, the pressing block has a perforation, the perforation of the pressing block allows the connecting shaft of the shaft lever to pass through, and the positioning post internal thread of the positioning post is screwed to the second external thread of the shaft lever.

4. The anti-disengagement fine-adjustable quick-detachable structure according to claim 1, wherein the shaft lever also has a washer which is sleeved on the small-diameter portion of the mandrel.

5. An anti-disengagement fine-adjustable quick-detachable structure, comprising:
a shaft lever having a mandrel, a connecting shaft and a C-shaped snap ring, the mandrel having a fixed end and a fine-adjustable end joined to the fixed end, a mandrel external thread being arranged on an outer circumferential surface of the fixed end, a mandrel internal thread being arranged on an end face of the fine-adjustable end, an annular groove being arranged on an outer circumferential surface of the fine-adjustable end, the connecting shaft having a first external thread at one end and a second external thread at the other end, the first external thread being screwed to the mandrel internal thread of the mandrel, and the C-shaped snap ring being clamped and secured on the annular groove;
a spanner rod having a positioning post internal thread which is screwed to the second external thread of the shaft lever; and
a fine-adjustable unit having an inner sleeve and an outer sleeve, the inner sleeve having an axially penetrating through hole and a fine-adjustable external thread, the outer sleeve being hollow annular, a small-diameter hole and a large-diameter hole communicated with the small-diameter hole being arranged on an inner circumferential surface of the outer sleeve, the inner diameter of the small-diameter hole being smaller than that of the large-diameter hole, a fine-adjustable internal thread being arranged on a hole wall of the small-diameter hole, the fine-adjustable internal thread of the outer sleeve being screwed onto the fine-adjustable external thread of the inner sleeve such that the outer sleeve can rotate under an external force to move in a reciprocating manner along an axial direction of the inner sleeve, the through hole of the inner sleeve allowing the connecting shaft of the shaft lever to pass through, the inner diameter of the large-diameter hole being greater than the outer diameter of the C-shaped snap ring, and the inner diameter of the small-diameter hole being smaller than the outer diameter of the C-shaped snap ring.

6. The anti-disengagement fine-adjustable quick-detachable structure according to claim 5, wherein the inner sleeve of the fine-adjustable unit has a head and a body joined at one end of the head, the through hole axially penetrates through the head and the body, the outer diameter of the head is greater than that of the body, and the fine-adjustable external thread is located on an outer circumferential surface of the body.

7. The anti-disengagement fine-adjustable quick-detachable structure according to claim 5, wherein the spanner rod has a rod body, a positioning post and a pressing block, the positioning post internal thread is located at one side of the positioning post, the positioning post is placed in one end of the rod body and relatively movable, the pressing block has a perforation, the perforation of the pressing block allows the connecting shaft of the shaft lever to pass through, and the positioning post internal thread of the positioning post is screwed to the second external thread of the shaft lever.

8. An anti-disengagement fine-adjustable quick-detachable structure, comprising:
a shaft lever having a mandrel and a connecting shaft, the mandrel having a fixed end and a fine-adjustable end joined to the fixed end, a mandrel external thread being arranged on an outer circumferential surface of the fixed end, a mandrel internal thread being arranged on an end face of the fine-adjustable end, the connecting shaft having a first external thread at one end and a second external thread at the other end, and the first external thread being screwed to the mandrel internal thread of the mandrel;
a spanner rod having a positioning post internal thread which is screwed to the second external thread of the shaft lever; and
a fine-adjustable unit having a knob, the knob having a knob head, a knob body connected at one end of the knob head and a knob perforation penetrating through the knob head and the knob body, the outer diameter of the knob head being greater than that of the knob body, a knob external thread being arranged on an outer surface of the knob body, the knob perforation allowing the connecting shaft of the shaft lever to pass through, and the knob external thread being screwed to the mandrel internal thread of the shaft lever such that the knob can rotate under an external force to move in a reciprocating manner along an axial direction of the shaft lever.

9. The anti-disengagement fine-adjustable quick-detachable structure according to claim 8, wherein the spanner rod has a rod body, a positioning post and a pressing block, the positioning post internal thread is located at one side of the positioning post, the positioning post is placed in one end of the rod body and relatively movable, the pressing block has a perforation, the perforation of the pressing block allows the connecting shaft of the shaft lever to pass through, and the positioning post internal thread of the positioning post is screwed to the second external thread of the shaft lever.
